(19) United States
(12) Patent Application Publication
(10) Pub. No.: US 2010/0191606 A1
(43) Pub. Date: Jul. 29, 2010

(54) TAX CALCULATION EXTENSIBILITY TECHNIQUES

(75) Inventors: Gang Chen, Sammamish, WA (US); Mehul Shah, Redmond, WA (US); Dmitry Belikov, Redmond, WA (US); Kirk Blackwood, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/358,270

(22) Filed: Jan. 23, 2009

(51) Int. Cl. G06Q 40/00

(52) U.S. Cl. 705/19; 705/31

(57) ABSTRACT

Various technologies and techniques are disclosed for performing tax calculations. An add-in model is described for developing add-in(s) for performing tax calculations. The add-in(s) calculate taxes for one or more tax authorities for items contained in a transaction being processed by a point of sale application. The add-in model specifies functionality the add-in(s) need to implement before the add-in(s) can be used by the point of sale application. A method for configuring multiple add-ins is described. A first add-in is called to calculate a first partial tax owed and the first partial tax is received back. A second add-in is called to calculate a second partial tax owed and the second partial tax is received back. A total tax is calculated by adding the first partial tax with the second partial tax. A configuration user interface is also provided by the add-in.

### BACKGROUND

When people buy goods or services, some type of checkout application or cart is used to calculate the total of the order, plus any applicable taxes that need to be charged on the items or services being purchased. In retail stores, a point of sale application is sometimes used to replace traditional cash registers. A point of sale application automates the processing of the transaction from start to finish, and handles transactions such as sales, returns, work orders, layaways, and quotes. Most point of sale applications also provide inventory management features to indicate when items are running low in inventory so they can be replenished. Similarly, customer and order information is tracked so that they can be reviewed and analyzed for various purposes later.

In the online world, there are point of sale applications that are accessible over the Internet and/or that run on dedicated computers. Such applications are often called online shopping cart programs, or merchant processing programs. Many of these shopping cart programs also have inventory tracking and customer reporting features.

Regardless of the type of application that is used when a transaction is being processed for a customer, whether in a retail store, online, or over the phone, there are typically one or more taxes that need to be calculated based upon the specifics of the transaction. Taxes and tax calculations can vary greatly from jurisdiction to jurisdiction and change frequently. Furthermore, tax calculations need to respect the jurisdiction of the customer's location. Point of sale applications have to support the tax calculations for the particular jurisdictions in which they are being used. With most point of sale applications, the tax rates are typically stored in a database table of rates, or the tax rates and logic are hard-coded into the point of sale application within the program itself or a configuration file.

As a particular product is sold by new businesses in new markets, these existing solutions make it challenging to support additional tax rules (not just rates) for the jurisdiction requirements in these new markets. For example, some jurisdictions may have a tax rule that pertains to “prepared food”, which can be found in convenience stores, gas stations, snack bars, and so on. Suppose such a rule is mandated by a tax authority as follows: “You must charge 8 percent on prepared foods if the total charge is more than $4.00. You must calculate this tax before the federal goods and services tax, and show it separately on the receipt.” This rule has multiple levels of requirements that are not met by storing a state and a sales tax rate in a configuration file or database table.

### SUMMARY

Various technologies and techniques are disclosed for performing tax calculations. An add-in model is described for developing add-in(s) for performing tax calculations. The add-in(s) are responsible for calculating taxes for one or more tax authorities for one or more items contained in a transaction that are being processed by a point of sale application. The add-in model specifies functionality that the add-in(s) need to implement before the add-in(s) can be used by the point of sale application.

A method for configuring multiple add-ins for a point of sale application is described. Processing is started for a transaction in a point of sale application. A first add-in is called to calculate a first partial tax owed for the transaction. The first partial tax is received from the first add-in. A second add-in is called to calculate a second partial tax owed for the transaction. The second partial tax is received from the second add-in. A total tax for the transaction is calculated by adding the first partial tax with the second partial tax.

A configuration user interface is also provided by an add-in to enable the user of point of sale application to modify details in the add-in. This user interface can also involve interaction elements between the user and the add-in to cover the specifics of a particular taxation law. From an add-in responsible for calculating partial taxes for a transaction for one or more tax authorities, a request is received from a point of sale application to invoke a configuration user interface. In one implementation, at least some functionality that is provided by the configuration user interface has been defined by an add-in model. In response to the request from the point of sale application, the configuration user interface is displayed by the add-in to enable a user to modify one or more details of the add-in from within the point of sale application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view illustrating an exemplary interdependency between taxing authorities.

FIG. 2 is a diagrammatic view of one implementation illustrating an add-in model for developing add-ins for performing tax calculations.

FIG. 3 is a simulated screen for one implementation that illustrates how a sales tax can be defined with a collection of tax authorities.

FIG. 4 is a diagrammatic view of one implementation illustrating an exemplary transactional object model.

FIG. 5 is a diagrammatic view of one implementation illustrating a tax authority application programming interface.

FIG. 6 is a process flow diagram for one implementation illustrating the stages involved in registering a tax authority add-in.

FIG. 7 is a process flow diagram for one implementation that illustrates the stages involved in loading and using a tax authority add-in.

FIG. 8 is a process flow diagram for one implementation that illustrates the stages involved in managing sales tax for one or more tax authorities.

FIG. 9 is a process flow diagram for one implementation that illustrates the stages involved in processing a transaction.

FIG. 10 is a diagrammatic view of a computer system of one implementation.

### DETAILED DESCRIPTION

The technologies and techniques herein may be described in the general context as an add-in model for tax calculations, but the technologies and techniques also serve other purposes in addition to these. In one implementation, one or more of the techniques described herein can be implemented as features within a point of sale program, or from any other type of program or service that participates in the processing of customer transactions at a retail store, online, and/or by telephone.

In one implementation, an add-in model is provided for a point of sale application that allows tax authority add-ins to be created for performing tax calculations. The term “point of sale application” as used herein is meant to include an application that is responsible for processing customer transactions, which can include sales, order, layaway and/or other transactions that are being processed in a retail store, online, and/or over the internet. The term “add-in” as used herein is meant to include a computer program that interacts with a host application to provide a certain, usually very specific, function “on demand”. A host application (such as a point of sale application in this example) can support add-ins for various reasons, such as to enable third-party developers to create capabilities to extend an application, and to support features unforeseen when the host application is being created. An add-in can be released as part of the point of sale application or as a standalone program. Add-ins that implement rules specific to the jurisdiction(s) in which the store operates and/or in which a customer resides can be dynamically loaded and utilized for tax configuration and tax calculations by the point of sale application. In one implementation, these add-ins can be developed by third-party developers who wish to customize the point of sale application for markets that the Point of Sale application was not initially designed to support out-of-box.

At the time the point of sale application is developed, current tax rules are known and the taxes can be calculated for transactions based on those rules. However, after the point of sale application is developed and deployed, there could be legislative changes that lead to new tax regulations that may not have been anticipated at the time of releasing the point of sale application, or the point of sale application can be deployed into new jurisdictions having different tax rules. These rules can be addressed by retail businesses by utilizing the add-in model. New regulations can be put in place for the point of sale application by simply updating the add-in for performing tax calculations and then deploying the new add-in rather than updating the point of sale application.

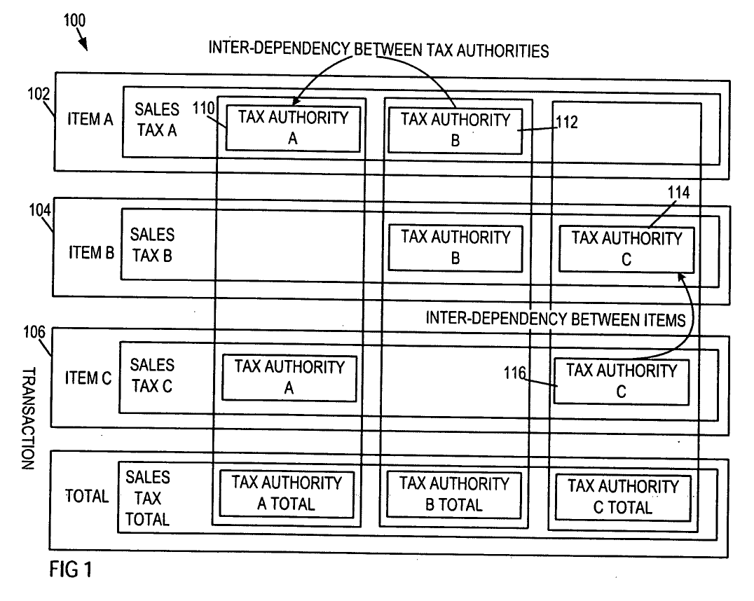

FIG. 1 is a diagrammatic view 100 illustrating an exemplary interdependency between taxing authorities. An inventory item (sometimes referred just as item in this document) is an entity that has an identifier and a set of properties, such as price, description, etc. Examples of taxable entries are shown on FIG. 1 as 102, 104, and 106. A transaction is typically a sale or an order that consists of multiple items, such as 102, 104, and 106 as a collection of items. Each line item represents an item, a specific quantity for the item, and other properties associated with this item in this transaction, such as charge, discount, different sales tax, etc. In some implementations, a shipping charge can be considered to be a line item, but it has neither item nor quantity associated with it. For each transaction, tax is calculated based on a definition of sales tax that is associated with each item in the transaction. Each line item corresponds to a charge or amount charged to the customer.

A charge could be further divided into multiple different portions called charge portion, such as “purchase now portion”, “on order portion”, etc. For example, in a sales transaction when an item is purchased outright, there is only one charge portion which is the purchase now portion. In an order where the customer is ordering an item by paying a deposit, the deposit could be a certain percentage of the total charge for the item. In this case, there is a purchase now portion for the deposit portion that the customer is paying at the time of placing the order and on order portion which the customer would pay at the time of picking up the order.

A tax authority refers to an entity to which sales tax is due, such as a city or state or regional agency. If a tax authority issued two separate laws for food and electronics, there could be “tax authorities” for each law (with different rules, rates, etc). Sales tax for an item is determined by one or more tax authorities that are applicable for a line item. The total value of sales tax calculated for a line item is the summation of partial tax calculated for each tax authority. The partial tax calculated for each tax authority for a line item in a transaction is based on rules specific to the tax authority. For example, a city tax may be a fixed % of the line item charge but the state tax could have a variable % depending on the quantity purchased.

There can be inter-dependency between tax authorities in certain scenarios, and the order of tax authorities in a sales tax could be important. As one non-limiting example, partial tax due to one tax authority could be calculated based on the item charge as well as the partial tax charged by another tax authority. In such a scenario, the latter tax authority would be ordered prior to the former tax authority. This is usually called “tax on tax”. An example of this is shown on FIG. 1 with tax authority A 110 being inter-dependent with tax authority B 112 on item A.

Alternatively or additionally, there can be inter-dependency between items in certain scenarios. For example the partial tax for a tax authority on a line item may depend on other line items included in the same transaction, such as tax authority C for item C 116 which depends on tax authority c for item B 114. When new items are added to transaction, the calculated tax on items that already exist in the transaction could be changed. For example, when the total of certain type of items, such as groceries, exceeds a certain amount, a different tax rate is then applied to all grocery items. An explanation will now be provided for how an add-in model can be used in one implementation to provide a flexible structure for implementing tax authorities and allowing them to be modified over time.

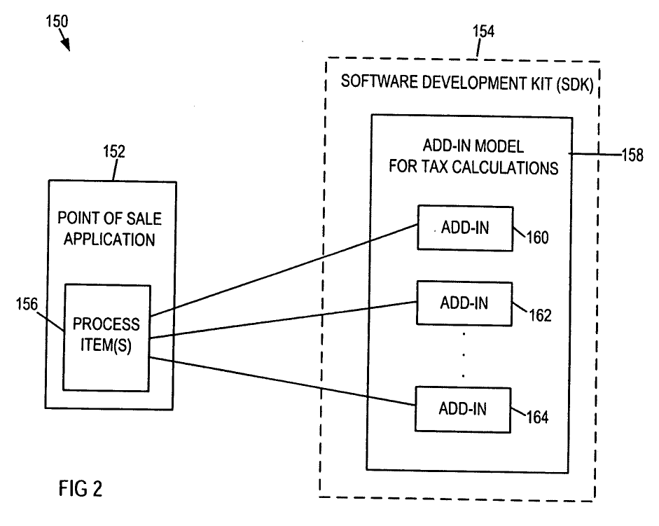

FIG. 2 is a diagrammatic view of a system 150 of one implementation including an add-in model 158 for developing add-ins for performing tax calculations. In one implementation, the add-in model 158 is documented for developers or other users through a software development kit 154. In other implementations, a software development kit 154 is not used at all. The add-in model 158 provides a series of definitions that define what features an add-in taking advantage of the model needs to provide. For example, a standard set of properties, methods, and/or events that each add-in needs to support in order to provide the expected functionality would be documented and supported by add-in model 158.

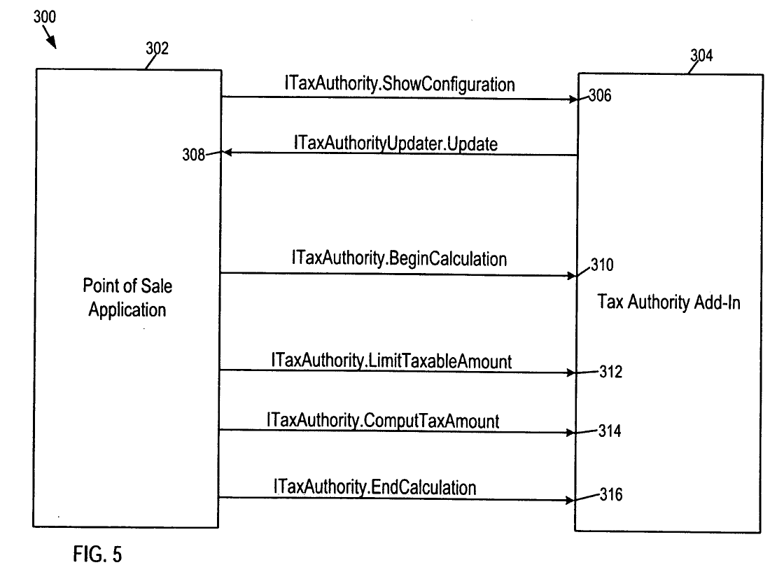

Point of sale application 152, through a tax authority application programming interface of add-in model 158, then provides details of the transaction to a tax calculation add-in (such as add-in 160, 162, or 164). An exemplary tax authority API is described in further detail in FIG. 5. The tax calculation add-in then calculates taxes based on rules specific to the applicable tax authority and communicates back to point of sale application.

Within a retail application, the store owner can create a set of sales taxes. As noted earlier, each taxable entry (item, shipping charge, etc.) is assigned a specific sales tax. The sales tax assigned to a taxable entry can be assigned based on various criteria. For example, the sales tax can be assigned based upon the department or category the item belongs to. Items in the apparel department may have a different sales tax than items in the bakery department. As another non-limiting example, a sales tax could contain, say, City, State and apparel tax. And it can be called “California Apparel Sales Tax” or any other names.

A sales tax is composed of one or more tax authorities. Each tax authority represents an authority that collects sales tax in a transaction. For example: the state of California collects a sales tax on a transaction and would represent one such tax authority. In addition, the city of San Diego in Calif. may collect sales tax on a transaction and would represent another tax authority. Tax authorities in a sales tax are specified in a particular order. By specifying the order, it is possible to impose tax on tax as required by some jurisdictions. For example: the city of San Diego may apply a sales tax based on price of item that includes the sales tax for the state of California. When items are being processed for a transaction 156, point of sale application 152 calculates tax for each line item in a transaction based on rules specific to each tax authority and combines tax for each tax authority to make up the total sales tax for the line item. These rules for each specific tax authority can be contained in the one or more add-ins (such as add-ins 160, 162, and 164) and the result of the calculation returned back to point of sale application 152.

By developing add-ins for the point of sale application 152 based upon the add-in model 158 (with or without software development kit 154), new add-ins can be added over time, and/or the existing add-ins (such as add-ins 160, 162, and 164) can be modified without having to change the underlying functionality of the point of sale application 152. In other words, such tax calculation add-ins can be developed and deployed after the point of sale application 152 is released. By doing so, tax calculation functionality can be expanded when the point of sale application 152 is sold in new markets with different jurisdictions and tax rules, and/or when existing jurisdictions change their rules.

Let's look at an example to demonstrate how this works in further detail. Suppose, for example, an inventory item “Sandwich” has been assigned a specific sales tax “Canadian sales tax”, which consists of two tax authorities, “OPST” and “GST” in order. When one “Sandwich” is added to transaction for sale, the point of sale application 152 looks into the list of tax authorities for “Canadian sales tax” and find out “OPST” can be calculated by an external add-in pre-registered with the application (such as add-in 160). The point of sale application 152 calls the external add-in (add-in 160 in this example), provides detail from the transaction such as item information, price, quantity, etc. The add-in (add-in 160) then calculates partial tax for tax authority “OPST” and returns that value back to the point of sale application 152. After partial tax for tax authority “OPST” is calculated, the application moves on to next tax authority in the sales tax, “PST”. If the point of sale application 152 has built-in support to calculate for “PST”, a partial tax corresponding to tax authority “PST” is calculated. Then, sales tax is calculated for the item added by combining partial tax calculated for both tax authorities.

In one implementation, the point of sale application 152 supports scenarios where the retailer ships goods to customers in multiple destinations and wants the add-in model 158 to calculate taxes based on the jurisdiction of the customer's shipping or billing address. For example, in one implementation, for each inventory item, there could be a different “sales tax” defined in the application for each customer location. Depending on the customer location (shipping or billing address), the point of sale application selects the appropriate sales tax. The sales tax comprises of one or more tax authorities. If add-ins are defined to calculate the tax for those tax authorities they would be called to calculate the tax accordingly.

In another implementation, there may be only one sales tax defined in the application for each inventory item. The sales tax contains multiple tax authorities. If add-ins are configured to calculate tax for these tax authorities, they would be called by the application to calculate the tax for the tax authority regardless of the customer shipping or billing address. Note that in this implementation, the add-in may, depending on the customer shipping and billing address, apply different rules for calculating tax.

Typically, depending on the customer location, the authority (government entity) that collects tax is different. That is, if shipping address is New York, the city of New York would collect city tax and not city of San Diego. In the first implementation, each tax authority maps to one entity that collects tax. In the second implementation, each tax authority represents tax collection on behalf of different entities depending on the billing/shipping address of the customer.

In another implementation, the add-in model 158 supports the ability for the point of sale application to handle tax calculations for transactions involving partial delivery. Partial delivery involves scenarios where some quantities of items in a transaction are delivered to the customer immediately and some quantities of the items are on order for later delivery. In such scenarios, the point of sale application can use add-in model 158 along with data stored in the application database about prior transactions to recall partial orders to complete the sales transaction with the proper taxes being calculated. In this scenario, when the application calls the tax calculation add-in, it passes information about the partial delivery so that the tax calculation add-in can calculate taxes based on what is being delivered and charged for at each partial delivery.

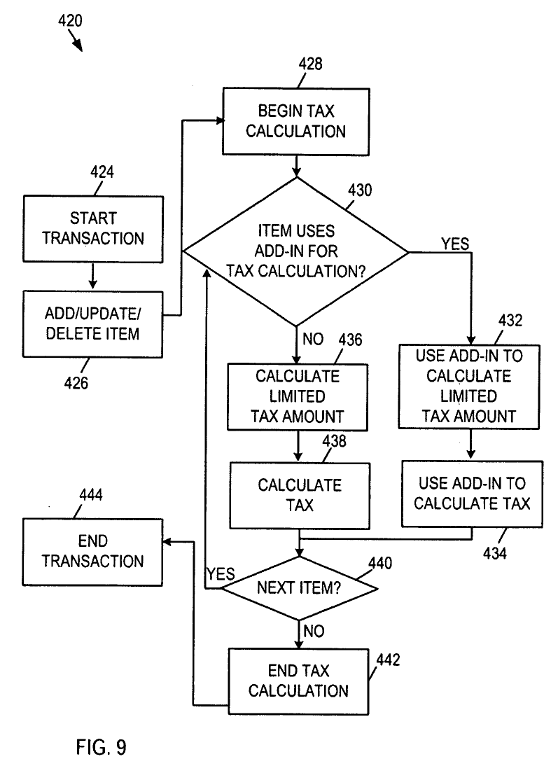

In another implementation, the add-in model 158 supports the ability for tax calculations to be handled for both VAT and non-VAT transactions, which is described in further detail with the discussion of FIG. 9.

In one implementation, when a tax authority add-in (such as add-in 160, 162, or 164) is installed on a computer system that has point of sale Application 152, the tax authority add-in needs to register with the point of sale application 152. Such registration information can include details such as name, description, etc. that will be stored in a database. In another implementation, add-ins are discovered at run-time during start-up by scanning the add-in folders and looking for their related files. In such an implementation, it can be sufficient to deploy an add-in onto a machine for the point of sale application to pick them it and start using it. Once deployed successfully, the respective tax authority add-in can be loaded when the application starts or at a later time upon request.

In some implementations, an add-in not only implements certain tax calculations based on published rules, but also can evolve itself to adopt later changes/updates, for example, by downloading additional updates or new schedules from the Internet or over another source.

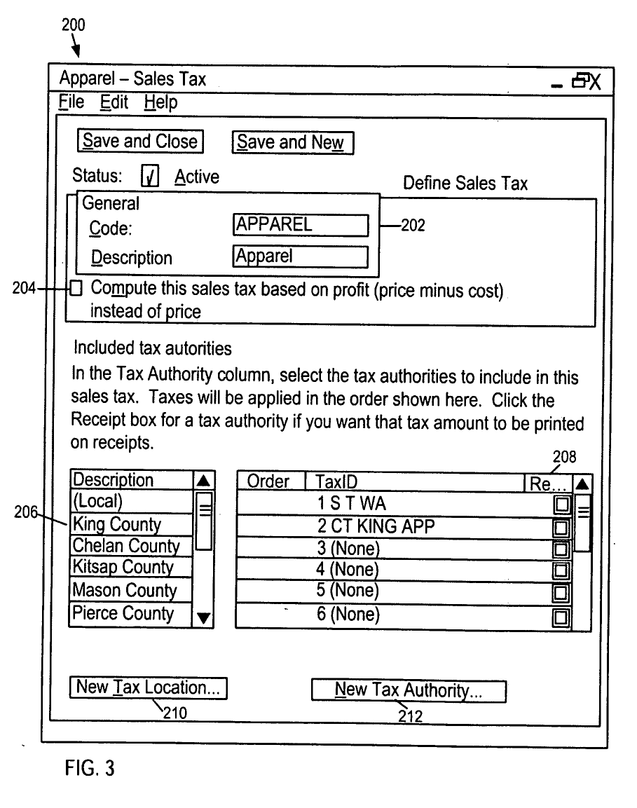

In one implementation, point of sale application 152 has a user interface to maintain relationships between items and sales tax, and/or between sales tax and tax authority. An exemplary user interface is shown in FIG. 3, which is discussed next.

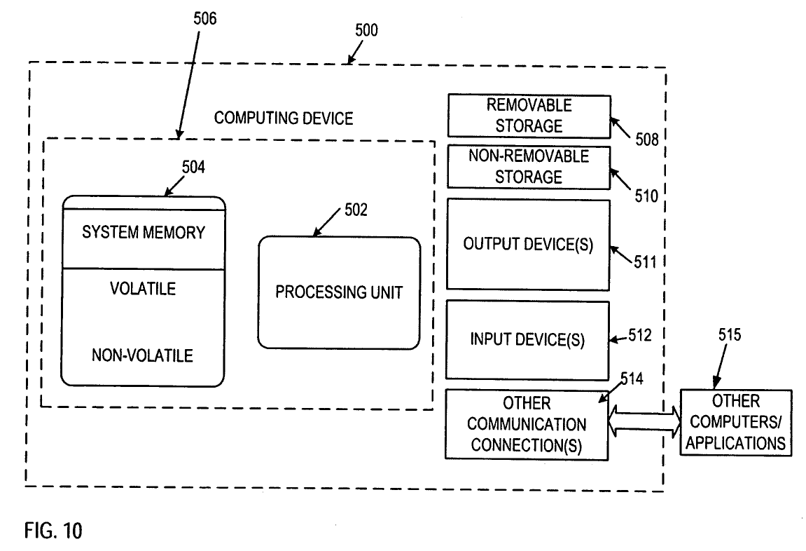

Turning now to FIGS. 3-9, the stages and techniques for implementing one or more implementations of system 150 are described in further detail. In some implementations, the processes and techniques of FIG. 3-9 are at least partially implemented in the operating logic of computing device 500 (of FIG. 10).

FIG. 3 is a simulated screen of a user interface 200 for one implementation that illustrates how a sales tax can be defined with a collection of tax authorities. When configuring sales tax for a taxable entry (such as an item or shipping charge), the applicable tax authorities are created and added to the sales tax. When a merchant chooses to add a new tax authority to a sales tax, he can choose to create a tax authority from the available installed tax authority Add-ins. The point of sale application then invokes user interface 200 from the tax authority add-in using application programming interface of the add-in model, so the tax authority add-in can display configuration information. In other words, the SDK provides configuration specifications that provide details for what each add-in needs to implement in order to provide a configuration user interface to the point of sale application. The configuration properties are captured for the tax authority by the tax authority add-in. As is described in further detail herein, the add-in can elect to save such information to the point of sale application's data store with application programming interface of the software add-in model.

Various details for the one or more tax authorities of an add-in can be modified using user interface 200. For example, an option to specify whether or not to compute this sales tax based on profit 204 can be specified. The tax authorities 206 that are to be included in this sales tax calculation can be specified, along with the ordering specified by the priority listing 208. New tax locations can be defined by selecting new tax location option 210, which would define tax authorities for the sales tax at different locations such as different customer shipping address, and new tax authorities can be defined by selecting new tax authority option 212. Configuration details can alternatively or additionally include the tax rates being charged by each tax authority, quantity limits on how many items need purchased before a certain tax is imposed for the one or more tax authorities, tax limits that define a maximum amount of tax that can be charged, etc. These are just a few non-limiting examples of the types of configurations that can be provided by user interface 200 (including the configuration user interface provided by tax authority add-in). Various other configurations could be used instead of or in addition to these in other implementations. The tax authority add-in then saves the configuration information for the configured tax authority.

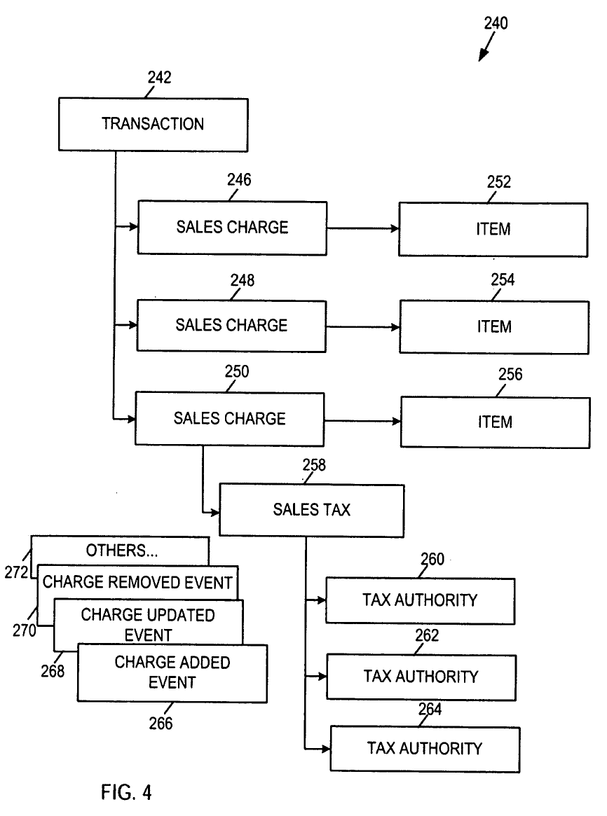

FIG. 4 is a diagrammatic view of one implementation illustrating an exemplary transactional object model 240. Transactional object model 240 consists of a list of entities exposed by a point of sale application that can be referenced by a tax authority add-in. Each transaction contains a collection of one or more sales charges (such as sales charge 246, sales charge 248, and sales charge 250). Each sales charge represents the charge on a “taxable entry” (such as item 252, item 254, item 256). Each sales charge has a property called sales tax, which contains a collection of tax authorities that have all the details that describe a tax authority. A set of events is provided as part of object model that a tax authority add-in to can subscribe to receive. Some examples of events that can be included in transactional object model 240 include charge added event 266, charge updated event 268, charge removed event 270, and other events 272.

Let's walk through an example to illustrate how this works. When the point of sale application starts a transaction and adds an item to the transaction, the sales tax that is associated with the item added will be identified. For example, when the first item 252 is added, the first sales charge 246 is added. When the second item 254 is added, the second sales charge 248 is added. When the third item 256 is added, the third sales charge 250 is added, and so on. As shown in FIG. 4, for sales charge 250, sale tax 258 is identified, and a list of tax authorities that are associated with sale tax 258 is retrieved from database.

The tax authority add-in(s), such as tax authority 260, tax authority 262, and tax authority 264, are then called in order to calculate the sales tax 258. During the process, the point of sale application can provide information to the add-in(s) through a tax authority application programming interface. The tax authority add-in can access the events and entities of the transactional object model 240 for additional information about the transaction to assist in performing the tax calculation. Once partial tax amount is returned by one tax authority add-in (such as tax authority 260), the point of sale application will move on to next tax authority (such as tax authority 262). After all partial tax amounts are calculated, sales tax 258 is then calculated.

FIG. 5 is a diagrammatic view of one implementation illustrating a tax authority API 300, which stands for application programming interface. The term API as used herein stands for “application programming interface”. Tax authority API 300 contains a set of contracts for communication between a point of sale application 302 and tax authority add-in 304. In one implementation, tax authority API 300 has at least two interfaces, one that allows the application to call into the tax authority add-in, and one that allows the tax authority add-in to call back to the point of sale application.

The point of sale application 302 can call into the tax authority add-in for configuration information using point 306, and the add-in can call back with information to be stored in the point of sale application's database at point 308. The overall transaction is initiated at point 310 to begin the calculation. The point of sale application then calls into the tax authority add-in 304 to calculated the limited taxable amount and the taxable amount sequentially at points 312 and 314, and the calculation then ends at point 316. It will be appreciated that these are just a few examples of the types of interfaces that can be provided in tax authority API 300. Numerous other interfaces could be used instead of, or in addition to these in alternate implementations.

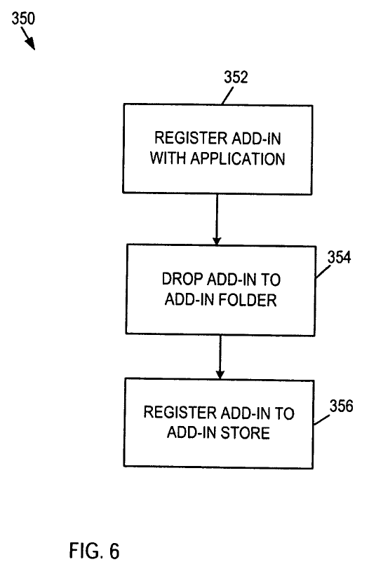

Turning now to FIGS. 6-9, some process flow diagrams are used to walk through the overall process of utilizing tax authority add-ins with a point of sale application.

FIG. 6 is a process flow diagram 350 that illustrates one implementation of the stages involved in registering a tax authority add-in. Once a tax authority add-in is developed (such as according to a tax authority API), the add-in is registered with the point of sale application (stage 352). The add-in is placed into a certain folder that the point of sale application specifies, or is otherwise made accessible to the point of sale application (stage 354). Then, a routine, either standalone or part of application, is run, and the program is validated and added to a registry (stage 356). The registry could be contained in a local database or other form of data store that maintains add-in specific information, such as, location of the program, identifier, etc.

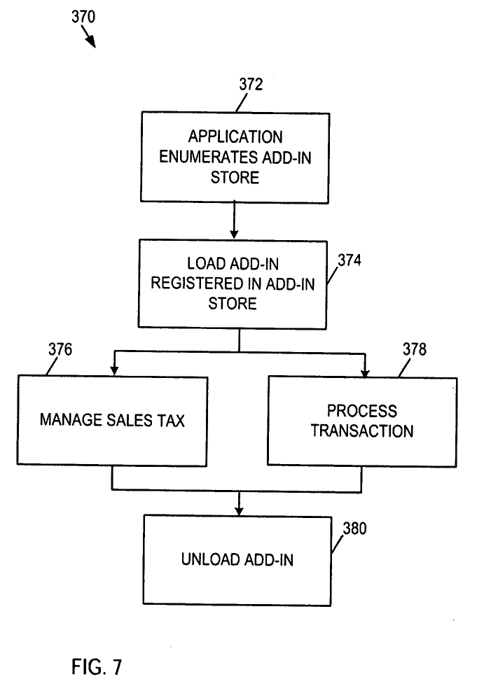

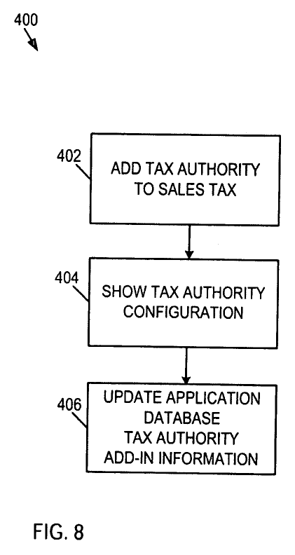

FIG. 7 is a process flow diagram 370 that illustrates one implementation of the stages involved in loading and using a tax authority add-in. When the point of sale application starts, the registry that keeps add-in specific information is enumerated to retrieve the valid add-ins (stage 372), and one or more add-ins can be loaded (stage 374). In some implementations, all of the add-ins are loaded at this point. In other implementations, they are loaded as they are needed for tax calculations. The point of sale application can use the information provided by the registry to communicate with the add-in when it performs one of two tasks, manage sales tax (stage 376) and process transaction (stage 378). The manage sales tax process is described in further detail in FIG. 8, and the process transaction process is described in further detail in FIG. 9. The add-in is later unloaded when it is no longer needed (stage 380).

FIG. 8 is a process flow diagram 400 that illustrates one implementation of the stages involved in managing sales tax for one or more tax authorities. The point of sale application usually provides ways to define sales tax through a user interface, such as the one shown in FIG. 3. When a tax authority add-in is selected to be part of certain sales tax (stage 402), the point of sale application will call the add-in so that tax authority can be configured (stage 404). Once the tax authority is configured, the tax authority add-in can elect to save configuration information in the point of sale application database by using the tax authority API (stage 406). For example, for a tax authority add-in that implements a threshold, such configuration information can include the tax rate, threshold, etc.

FIG. 9 is a process flow diagram 420 that illustrates one implementation of the stages involved in processing a transaction. During a transaction, items can be added, deleted, updated with quantity, price, discount, etc. When any of this happens, point of sale application can elect to have tax for the entire transaction calculated by calculating partial tax of each tax authority and total all partial taxes calculated. In one implementation, the tax calculation is bracketed in a pair of API calls, (such as BeginCalculation and EndCalculation), and the point of sale application ensures that no changes to items in transaction will happen between the two API calls.

When a transaction is started (stage 424), items can be added, updated, and/or deleted (stage 426). The tax calculation begins (stage 428). If the item uses an add-in for its tax calculation (decision point 430), then the add-in is used to calculated the limited tax amount (stage 432) and the tax (stage 434). If the item does not use an add-in for its tax calculation (decision point 430), then the point of sale application calculates the limited tax amount (stage 436) and the tax (stage 438). If there is a next item (decision point 440), then the process repeats at decision point 430 to process the next item. Otherwise, the tax calculation ends (stage 442).

Let's look at some more complex examples to further illustrate how some of the techniques described herein can work together. Assume there are three items added to a transaction, and the first item and the third item's sales tax specifies that a threshold tax authority is included. When any of the items change, each item's sales tax will be calculated. At that point, the first and the third item's partial tax for the threshold tax authority are calculated by the point of sale application by calling the add-in with the tax authority API.

When the threshold tax Authority calculates tax, one of the parameters is the transaction gross total. Gross total can be calculated in different ways. One way is to enumerate all the item charges at the beginning of the calculation (BeginCalculation) and calculate the sum of all charges, since the item charges are exposed to the add-in through the transactional object model. Another way to calculate the gross total is to have the add-in to listen to events fired by the point of sale application through the transactional object model. For example, when a charge added event is fired, the gross total is updated with the new item charge that was added.

With gross total being up-to-date, the threshold tax authority can calculate tax by comparing the gross total with the threshold at the time when it is called by the point of sale application.

Another interesting example is when value added tax (VAT tax) is being considered. A VAT tax scenario is slightly different than a straight excusive tax scenario since the point of sale application doesn't know enough detail to calculate the tax excluded item price up front without knowing the detail of the way the tax is calculated by each individual tax authorities. This is especially true when there are multiple tax authorities involved.

Here's an example of how some more complex VAT scenarios can be handled by system 150. Suppose an item is sold at gross price of $10 in a VAT system, and there are two tax authorities involved in sale, VAT_TA1 and VAT_TA2. Further suppose that VAT_TA1 has a flat amount of 50 c and VAT_TA2 has a tax rate of 10%. The tax excluded item price x can be resolved by following formula, x+0.5+x*10%=10, which is, $8.64. Alternatively, assuming VAT_TA2 is calculated after previous tax already charged (a.k.a “Tax on Tax”), the tax excluded item price x would be resolved by formula, (x+0.5)*(1+10%)=10, which is $8.59.

One of the ways to calculate tax in aforementioned scenario is based upon a two-pass communication with the tax authority add-ins. When the point of sale application calculates tax for a certain item added to the transaction, the point of sale application queries each tax authority for the “formula” about how they calculate tax, (i.e. the 1st pass). The point of sale application then combines the formulas it acquires and resolves the tax excluded item price from the formula. Then, the point of sale application passes the tax excluded item price to each tax authority add-in and calculates its own tax, (i.e. the 2nd pass). It is worth to point out, with this two-pass communication, the complexity of order of tax authority and “Tax on Tax” calculation is hidden from the tax authority add-ins and achieved by the point of sale application, with the point of sale application knowing the detail at the sales tax level and being responsible for generating the combined formula.

As shown in FIG. 10, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 10 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 10 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

In one implementation, computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A system for enabling extensible tax calculations comprising:
an add-in model for developing an add-in for performing a tax calculation, the add-in to be responsible for calculating taxes for one or more tax authorities for one or more items contained in a transaction that are being processed by a point of sale application, and the add-in model specifying functionality that the add-in needs to implement before the add-in can be used by the point of sale application.

2. The system of claim 1, wherein the add-in model is operable to specify one or more properties, methods, and events as functionality that the add-in needs to implement.

3. The system of claim 1, further comprising:
a tax authority application programming interface that enables the point of sale application to call the add-in to initiate the tax calculation.

4. The system of claim 1, further comprising:
a tax authority application programming interface that enables the add-in to call the point of sale application to manage information the add-in needs to perform the tax calculation.

5. The system of claim 1, further comprising:
configuration specifications that describe how the add-in can provide a configuration user interface to enable one or more users of the point of sale application to configure the add-in.

6. The system of claim 1, wherein the add-in model supports development of one or more add-ins that can calculate both VAT and non-VAT taxes.

7. The system of claim 1, wherein the add-in model enables multiple add-ins to be used by the point of sale application.

8. The system of claim 1, wherein the add-in model enables the point of sale application to handle tax calculations for transactions involving partial delivery.

9. A method for configuring multiple add-ins for a point of sale application comprising the steps of:
starting processing for a transaction in a point of sale application;
calling a first add-in to calculate a first partial tax owed for the transaction;
receiving the first partial tax from the first add-in;
calling a second add-in to calculate a second partial tax owed for the transaction;
receiving the second partial tax from the second add-in; and
calculating a total tax for the transaction by adding the first partial tax with the second partial tax.

10. The method of claim 9, wherein the first add-in is called for a first tax authority in the transaction and wherein the second add-in is called for a second tax authority in the transaction.

11. The method of claim 9, wherein the first add-in calculates the first partial tax owed to a first tax authority, and wherein the second add-in calculates the second partial tax owed to a second tax authority.

12. The method of claim 9, wherein the second add-in calculates the second partial tax that is based upon the first partial tax.

13. The method of claim 9, wherein the first add-in and the second add-in are loaded from an add-in store.

14. The method of claim 9, further comprising the steps of:
prior to calculating the total tax, calling one or more additional add-ins to calculate additional partial taxes for a remainder of the transaction.

15. The method of claim 9, wherein the first add-in uses a tax authority application programming interface to retrieve data from the point of sale application in calculating the first partial tax owed.

16. The method of claim 9, wherein the second add-in uses a tax authority application programming interface to retrieve data from the point of sale application in calculating the second partial tax owed.

17. A computer-readable storage medium having computer-executable instructions for causing a computer to perform steps comprising:
in an add-in responsible for calculating partial taxes for a transaction for one or more tax authorities, receiving a request from a point of sale application to invoke a configuration user interface, where at least some functionality that is provided by the configuration user interface has been defined by a software development kit; and
in response to the request from the point of sale application, displaying the configuration user interface to enable a user to modify one or more details of the add-in from within the point of sale application.

18. The computer-readable storage medium of claim 17, wherein the details displayed by the configuration user interface includes one or more tax rates assigned to the one or more tax authorities.

19. The computer-readable storage medium of claim 17, wherein the details displayed by the configuration user interface includes quantity limits on how many items need purchased before a certain tax is imposed for the one or more tax authorities.

20. The computer-readable storage medium of claim 17, wherein the details displayed by the configuration user interface includes tax limits that define a maximum amount of tax that can be charged.
